(19) United States
(12) Patent Application Publication
(10) Pub. No.: US 2026/0368947 A1
(43) Pub. Date: Nov. 19, 2026

(54) FREQUENCY DOMAIN DIFFUSION GUIDANCE

(71) Applicants: Disney Enterprises, Inc., Burbank, CA (US); ETH Zürich (Eidgenössische Technische Hochschule Zürich), Zürich (CH)

(72) Inventors: Seyedmorteza Sadat, Dübendorf (CH); Romann Matthew Weber, Uster (CH); Farnood Salehi, Zurich (CH); Tobias Vontobel, Zurich (CH)

(73) Assignees: Disney Enterprises, Inc., Burbank, CA (US); ETH Zürich (Eidgenössische Technische Hochschule Zürich), Zürich (CH)

(21) Appl. No.: 19/355,880

(22) Filed: Oct. 10, 2025

Related U.S. Application Data
(60) Provisional application No. 63/805,840, filed on May 14, 2025.

(51) Int. Cl. G06T 11/00; G06T 5/70

(52) U.S. Cl. CPC G06T 11/00; G06T 5/70

(57) ABSTRACT

In some embodiments, a generative model determines a conditional output and an unconditional output for denoising a noisy sample. A method determines a frequency decomposition of the conditional output and the unconditional output from a data space to generate a low frequency conditional output, a low frequency unconditional output, a high frequency conditional output, and a high frequency unconditional output. Low frequency components are computed by applying a first weight to the low frequency conditional output and the low frequency unconditional output. High frequency components are computed by applying a second weight to the high frequency conditional output and the high frequency unconditional output. The method converts the low frequency components and the high frequency components to a guided prediction in the data space. A denoised output based on the guided prediction where the denoised output is used to generate a generative output by the generative model.

### CROSS REFERENCE TO RELATED APPLICATIONS

Pursuant to 35 U.S.C. § 119(e), this application is entitled to and claims the benefit of the filing date of U.S. Provisional App. No. 63/805,840 filed May 14, 2025, entitled “FREQUENCY DOMAIN DIFFUSION GUIDANCE”, the content of which is incorporated herein by reference in its entirety for all purposes.

### BACKGROUND

Classifier-free guidance (CFG) is a technique used in diffusion models to enhance image quality and alignment with conditioning inputs, such as text prompts. Typically, diffusion models rely on high guidance scales to achieve these improvements. However, high guidance scales degrade sample diversity and introduce color saturation artifacts. Conversely, low CFG scales tend to produce more diverse samples with natural color compositions but often suffer from poor global structure and lower visual fidelity.

To address these trade-offs, several empirical strategies have been proposed to balance diversity and quality in CFG. Despite this progress, a systematic understanding of how CFG improves image quality and prompt alignment remains limited. Existing works do not fully explain the internal mechanisms of CFG or explore methods to improve generation quality at low guidance scales.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for performing frequency-decoupled guidance according to some embodiments.

FIG. 2 depicts a simplified flowchart of a method for performing frequency-decoupled guidance according to some embodiments.

FIG. 3 depicts a simplified flowchart for performing rescaling according to some embodiments.

FIG. 4 illustrates one example of a computing device according to some embodiments.

### DETAILED DESCRIPTION

Described herein are techniques for a generative model system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

Classifier-free guidance (CFG) is a type of guidance technique used in generative models, such as diffusion models, that combines the predictions of a conditional model and an unconditional model. Classifier-free guidance modifies a denoiser's output at each sampling step by adding a weighted difference between the conditional and unconditional model predictions. This allows the model to generate high-quality samples while maintaining flexibility. In contrast to classifier-free guidance, classifier guidance refers to a technique used in generative models where a classifier is used to guide the generation process. The classifier provides additional information to the generative model about the desired output, which helps to improve the quality and alignment of the generated samples with the input condition.

Diffusion models are a class of generative models that learn a data distribution by reversing a forward process that adds noise to the data until the samples are indistinguishable from pure noise. Although simulating the backward process in diffusion models should result in correct sampling from the data distribution, unguided sampling from diffusion models often results in low-quality images that do not align well with the input condition (e.g., a prompt). Accordingly, classifier-free guidance increases the quality of generated outputs and increases the alignment between the condition and the generated image, albeit at the cost of reduced diversity. Text-to-image models generally require high guidance scales in order for the generation of output (e.g., images) to have better quality and align well with the input condition. A high guidance scale means that the model is more strongly guided by the conditional model's output compared to the unconditional model's output. However, high guidance scales often result in oversaturated colors and simplified image compositions.

The system analyzes a classifier-free guidance update rule in a frequency domain. This analysis reveals that classifier free guidance enhances image quality and prompt alignment through distinct frequency components. The system determines that low-frequency components primarily govern global structure and condition alignment. The system also determines that high-frequency components mainly contribute to visual quality and details. The system observes that excessive guidance in the low-frequency domain reduces diversity and causes oversaturation. The system further observes that high-frequency components benefit from higher guidance scales. Since standard classifier-free guidance applies a uniform scale across all frequencies, the system may use separate scales for low frequency components and high frequency components.

The system implements a frequency-decoupled guidance process that disentangles guidance scales applied to low-frequency and high-frequency components of a classifier-free guidance signal. In some embodiments, the system applies guidance more conservatively to low-frequency components to avoid low-diversity and oversaturated generations. Then, the system applies stronger guidance to high-frequency components to enhance image quality. The system assigns separate guidance strengths to these components to improve image quality while retaining diversity typically associated with low guidance scales. The use of separate scales for frequency components also avoids the drawbacks of high guidance scales as lower guidance scales may be used especially for the low frequency components.

The system introduces minimal additional sampling cost and applies to pretrained diffusion models without extra training or fine-tuning. The system consistently improves image quality and maintains diversity across datasets, models, and metrics. The system provides understanding of how classifier-free guidance enhances image quality and prompt alignment by separately analyzing roles of low-frequency and high-frequency components in the update rule. The system operates as a plug-and-play alternative to standard classifier-free guidance for conditional diffusion models.

### System

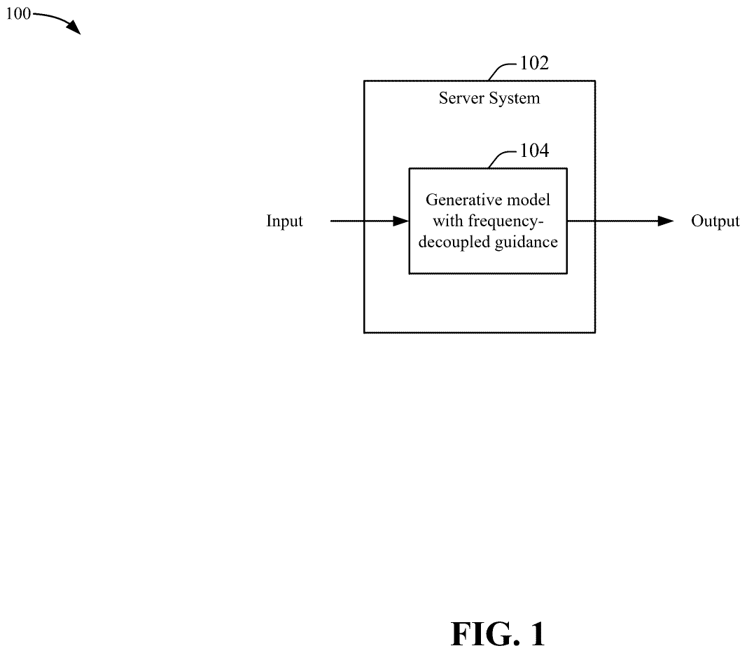

FIG. 1 depicts a simplified system 100 for performing frequency-decoupled guidance according to some embodiments. A server system 102 includes a generative model 104, such as a diffusion model, that performs frequency-decoupled guidance. Generative model 104 receives an input, such as text prompts, images, or audio signals, and generates an output. The output may be a perceptual output, such as images, videos, music, etc.

Generative model 104 generates an output by iteratively refining a random noise signal until it converges to a specific data distribution. The process involves a series of transformations that progressively remove noise from the input signal, allowing the model to learn complex patterns and structures within the data. If x~p_{data}(x) represents a data point, and if zₜ=x+σ(t)ϵ describes a forward process of the diffusion model that introduces noise to the data, where t∈[0, 1] is the time step. Here, zₜ is the noisy version of the input x, and σ(t) is the time dependent noise schedule, which determines the amount of information destroyed at each time step t, with σ(0)=0 (e.g., no noise added) and σ(1)=σₘₐₓ. (e.g., the maximum noise added). The forward process may be represented as:

dzₜ=−\dot{σ}(t)σ(t)∇_{z} log pₜ(zₜ)dt, (1)

where pₜ(zₜ) is the distribution over noisy samples at time t, with

$${p}_{0} = {p}_{data} and {p}_{1} = N ( 0 , {σ}_{max}^{2} I ) .$$

With access to the time-dependent score function ∇zₜ log pₜ(zₜ), generative model 104 can sample from the data distribution p_{data} by solving the equation (1) backward in time (from t=1 to t=0). The unknown score function ∇zₜ log pₜ(zₜ) is estimated using a neural denoiser D_{θ}(zₜ, t), which is trained to predict the clean samples x from the corresponding noisy samples zₜ. This framework also allows for conditional generation by training a denoiser D_{θ}(zₜ, t, y) that incorporates additional input signals y, such as class labels or text prompts, as conditions. The conditions may be based on the input that is received to generate the output or other conditions, and used to guide the conditional process.

Classifier-free guidance is an inference method designed to enhance the quality of generated samples by combining the predictions of a conditional model and an unconditional model. The input condition y could be additional information that is provided to generative model 104 to guide its output generation. For example, the input condition may be a text prompt, image, or other signals that the model uses to generate the output, such as an image or other type of output. Given a null condition yₙᵤₗₗ=Ø for the unconditional model, classifier-free guidance modifies the denoiser's output at each sampling step as follows:

\hat{D}_{CFG}(zₜ,t,y)=D_{θ}(zₜ,t,yₙᵤₗₗ)+w(D_{θ}(zₜ,t,y)−D_{θ}(zₜ,t,yₙᵤₗₗ)), (2)

where w=1 represents the non-guided case. The output of the denoiser is \hat{D}_{CFG}(zₜ, t, y) for the iteration, the output of the conditional model is D_{θ}(zₜ, t, y), and the output of the unconditional model is D_{θ}(zₜ, t, yₙᵤₗₗ). The unconditional model D_{θ}(zₜ, t, yₙᵤₗₗ) is trained by randomly applying the null condition yₙᵤₗₗ=Ø to the denoiser's input for a portion of training. The use of yₙᵤₗₗ=Ø means that the condition is not applied. Alternatively, a separate denoiser can be trained to estimate the unconditional output in Equation (2).

Generative model 104 processes an image using multi-level frequency decomposition. Generative model 104 separates the image into different frequency bands. In some embodiments, generative model 104 implements a Laplacian pyramid decomposition, a wavelet transform decomposition, or other methods for separating frequency components of an image. Generative model 104 decomposes the image into coarse, low-frequency structures and fine, high-frequency details.

Generative model 104 analyzes how different frequency components in a CFG prediction influence final generation. Generative model 104 captures global characteristics of the image using low-frequency components. These global characteristics include object placement, overall geometry, and color distribution. Generative model 104 represents localized information using high-frequency components. This localized information includes edges, textures, and fine structural details. The decomposition enables separate processing of different frequency components.

Generative model 104 applies guidance in a frequency domain to enhance characteristics of classifier-free guidance. Generative model 104 uses a frequency transformation denoted as ψ[⋅], which may be a linear and invertible frequency transformation. A linear and invertible frequency transformation may refer to a mathematical operation that transforms an image from one domain to another, such as from the data space (e.g., spatial domain) to the frequency domain. “Linear” means that the transformation preserves the operations of addition and scalar multiplication. In other words, if you have two input signals, x1 and x2, and you apply the transformation ψ[⋅] to a·x1+b·x2, the resulting transformed signals will be a·ψ[x1]+b·ψ[x2], where a and b are some constant scalars. “Invertible” means that the transformation has an inverse operation, denoted as ψ⁻¹( ). In some embodiments, generative model 104 implements a Laplacian pyramid transformation, a wavelet transform, or other frequency domain transformation process. This transformation decomposes an input x into low-frequency components ψ_{low}[x] and high-frequency components ψ_{high}[x].

Generative model 104 defines D_{c}(zₜ)≐D_{θ}(zₜ, t, y) to represent the conditional output, defines Dᵤ(zₜ)≐D_{θ}(zₜ, t, yₙᵤₗₗ) to represent unconditional output, and defines \hat{D}_{CFG}(zₜ)≐\hat{D}_{CFG}(zₜ, t, y) to represent the CFG output. Through properties of ψ, generative model 104 expresses the CFG update rule as:

\hat{D}_{CFG}(zₜ)=ψ⁻¹[ψ[\hat{D}_{CFG}(zₜ)]], (3)

=ψ⁻¹[ψ[Dᵤ(zₜ)]]+w(ψ[D_{c}(zₜ)]−ψ[Dᵤ(zₜ)])]. (4)

The CFG update in the frequency domain affects both low-frequency and high-frequency components of

$$ψ [ {\hat{D}}_{CFG} ( {z}_{t} ) ] = \{ {\hat{D}}_{CFG}^{low} ( {z}_{t} ) , {\hat{D}}_{CFG}^{high} ( {z}_{t} ) \}$$

as follows:

$${\hat{D}}_{CFG}^{low} ( {z}_{t} ) = {ψ}_{low} [ {D}_{u} ( {z}_{t} ) ] + w ( {ψ}_{low} [ {D}_{c} ( {z}_{t} ) ] - {ψ}_{low} [ {D}_{u} ( {z}_{t} ) ] ) , \qquad ( 5 )$$

$${\hat{D}}_{CFG}^{high} ( {z}_{t} ) = {ψ}_{high} [ {D}_{u} ( {z}_{t} ) ] + w ( {ψ}_{high} [ {D}_{c} ( {z}_{t} ) ] - {ψ}_{high} [ {D}_{u} ( {z}_{t} ) ] ) . \qquad ( 6 )$$

$${\hat{D}}_{CFG}^{low} ( {z}_{t} )$$

is the estimated low frequency component of the CFG output at time step zₜ, ψ_{low}[Dᵤ(zₜ)] is the low frequency component of the result of applying a linear and invertible frequency transformation, denoted as ψ_{low}, to the unconditional model output Dᵤ(zₜ), and ψ_{low}[D_{c}(zₜ)]−ψ_{low}[Dᵤ(zₜ)] is the difference between the low frequency components of the conditional model output and the unconditional model output. The value for the low frequency output for the unconditional model ψ_{low}[Dᵤ(zₜ)] is added to the w(ψ_{low}[D_{c}(zₜ)]−ψ_{low}[Dᵤ(zₜ)]), which is the weighted difference of the low frequency output for the conditional model and the low frequency output for the unconditional model. Also,

$${\hat{D}}_{CFG}^{high} ( {z}_{t} )$$

is the estimated high frequency component of the CFG output at time step t, ψ_{high}[Dᵤ(zₜ)] is the high frequency component of the result of applying a linear and invertible frequency transformation, denoted as ψ_{low}, to the unconditional model output Dᵤ(zₜ), and ψ_{high}[D_{c}(zₜ)]−ω_{high}[Dᵤ(zₜ)] is the difference between the high frequency components of the conditional model output and the unconditional model output. The value for the low frequency output for the unconditional model ψ_{high}[Dᵤ(zₜ)] is added to the w(ψ_{high}[D_{c}(zₜ)]−ψ_{high}[Dᵤ(zₜ)]), which is the weighted difference of the high frequency output for the conditional model and the high frequency output for the unconditional model.

In standard CFG, generative model 104 guides both low-frequency and high-frequency components using a same scale w throughout a sampling process. However, low-frequency components and high-frequency components exhibit different behaviors and influence distinct aspects of a generated image. Strong guidance on a low-frequency component

$${\hat{D}}_{CFG}^{low} ( {z}_{t} )$$

leads to oversaturation and reduced diversity of the outputted images. High guidance on a high-frequency component

$${\hat{D}}_{CFG}^{high} ( {z}_{t} )$$

primarily enhances image quality. Low scales for w_{low} maintain diversity and realistic color composition. Low values for w_{high} degrade visual details and result in reduced sample quality.

Generative model 104 implements separate guidance scales w_{low} for low-frequency components and w_{high} for high-frequency components. For CFG with w_{low}=w_{high}, low guidance scales lead to poor global structure and visual degradation while high guidance reduces diversity. Strong guidance on a low-frequency signal primarily causes diversity issues. Increasing the guidance on w_{high} enhances quality without adverse effects on diversity. Using a single scale w in standard CFG produces blurry or incoherent outputs at low values and reduces diversity with oversaturation at high values. Generative model 104 employs separate guidance scales—w_{low} for the low frequency components and w_{high} for the high-frequency components. In some embodiments, generative model 104 implements asymmetric guidance where w_{low} does not equal w_{high}, such as w_{low}<w_{high}, but w_{low}>w_{high} could be used in some cases if better results are generated.

The output of the model for the low frequency and high frequency components with separate scales may be as follows:

$${\hat{D}}_{FDG}^{low} ( {z}_{t} ) = {ψ}_{low} [ {D}_{u} ( {z}_{t} ) ] + {w}_{low} ( {ψ}_{low} [ {D}_{c} ( {z}_{t} ) ] - {ψ}_{low} [ {D}_{u} ( {z}_{t} ) ] ) , \qquad ( 7 )$$

$${\hat{D}}_{FDG}^{high} ( {z}_{t} ) = {ψ}_{high} [ {D}_{u} ( {z}_{t} ) ] + {w}_{high} ( {ψ}_{high} [ {D}_{c} ( {z}_{t} ) ] - {ψ}_{high} [ {D}_{u} ( {z}_{t} ) ] ) . \qquad ( 8 )$$

$${\hat{D}}_{FDG}^{low} ( {z}_{t} )$$

is the frequency-decouple guidance (FDG) low frequency component and

$${\hat{D}}_{FDG}^{high} ( {z}_{t} )$$

is the frequency-decoupled guidance high frequency component. The weights w_{low} and w_{high} are separate scales and can be set to different values.

The following will now discuss the frequency-decoupled guidance process in more detail.

### Frequency-Decoupled Guidance

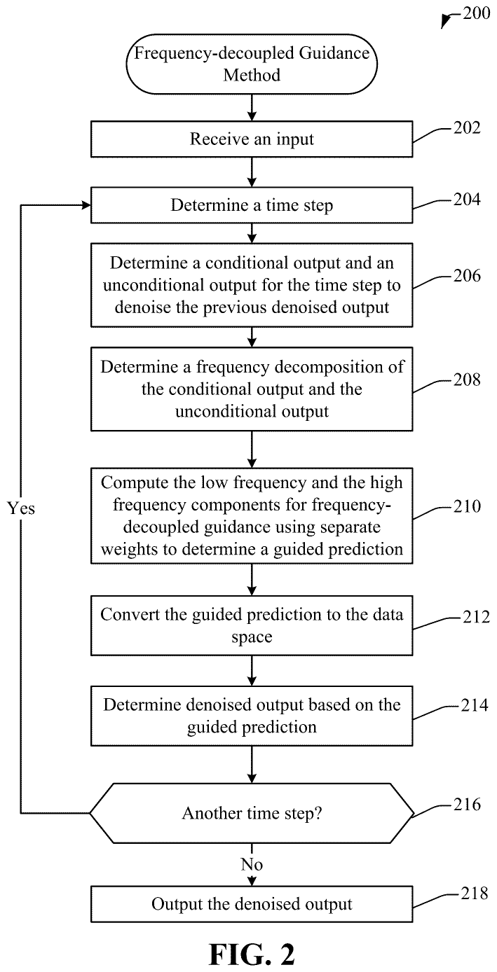

FIG. 2 depicts a simplified flowchart 200 of a method for performing frequency-decoupled guidance according to some embodiments. At 202, generative model 104 receives an input. The input may be different formats, such as text, audio, or other signals. In some embodiments, the input may be “Generate an image of an elephant”. Here, a user might want generative model 104 to generate an image of the elephant.

At 204, generative model 104 determines a time step t. The time step t may be the number of iterations of denoising that generative model 104 may perform to generate a denoised output of a noisy sample. The denoised output may be an image of the elephant.

At 206, for the time step, generative model 104 determines a conditional output and an unconditional output for denoising the previous denoised output. As mentioned above, generative model 104 may iteratively denoise a noisy sample in multiple iterations of time steps. The conditional output may be based on a condition of the input of generating an elephant. The unconditional output may be the prediction that is not based on the input of generating the elephant.

At 208, generative model 104 determines a frequency decomposition of the conditional output and the unconditional output. As discussed above, different frequency decompositions may be used. In some embodiments, generative model 104 constructs a Laplacian pyramid, which is a multi-scale representation of an image based on successive band-pass filtering. To do this, generative model 104 starts with an input image x and constructs a Gaussian pyramid. Each level of the pyramid is a progressively downsampled and low-pass filtered version of the previous level, obtained by applying a downsampling operation to the Gaussian-blurred previous level. Generative model 104 then forms a Laplacian pyramid by subtracting the upsampled version of each Gaussian level from its corresponding higher-resolution level. The top level of the pyramid is typically the final low-resolution image. Generative model 104 can invert this decomposition to reconstruct the original signal by sequentially upsampling and summing the Laplacian levels. This approach enables localized manipulation of image details at different spatial scales, making it suitable for applications such as image compression, enhancement, and blending.

In some embodiments, generative model 104 uses wavelet transforms to extract spatial-frequency characteristics from input data. Wavelet transforms rely on a pair of filters: a low-pass filter L and a high-pass filter H. For 2D signals, four filters are derived. When applied to an image x, the 2D wavelet transform decomposes it into a low-frequency sub-band and three high-frequency sub-bands, which capture horizontal, vertical, and diagonal details, respectively. Each sub-band has a spatial size of H/2×W/2 for an input image of size H×W. Generative model 104 can perform multi-resolution analysis by recursively applying the wavelet transform to the low frequency sub-band. The transform is also invertible, allowing generative model 104 to reconstruct the original image x from the set of low frequency sub-bands and high-frequency sub-bands using the inverse wavelet transform. For example, generative model 104 can use a fast wavelet transform (FWT) to compute wavelet sub-bands with linear complexity relative to the number of pixels in x. Other processes of transforming the image into low frequency components and high frequency components for the conditional output and the unconditional output may also be appreciated.

At 210, generative model 104 computes the low frequency components and the high frequency components for frequency-decoupled guidance using separate weights to determine a guided prediction. The weights w_{low} and w_{high} may be set on separate scales. In some embodiments, the weights are set as w_{low}<w_{high}. The result from equations 5 and 6 above is

$${\hat{D}}_{CFG}^{low} ( {z}_{t} ) and {\hat{D}}_{CFG}^{high} ( {z}_{t} ) .$$

At 212, generative model 104 converts the guided prediction to the data space. For example, an inverse transform is used as follows:

$${\hat{D}}_{CFG} ( {z}_{t} ) = {ψ}^{- 1} [ \{ {\hat{D}}_{CFG}^{low} ( {z}_{t} ) , {\hat{D}}_{CFG}^{high} ( {z}_{t} ) \} ] .$$

At 214, generative model 104 determines denoised output based on the guided prediction. The denoised output may be a prediction of which noise to remove from a previous denoised output, which is described as follows:

zₜ₋₁=diffusion_reverse(\hat{D}_{FDG},zₜ,t),

wherein diffusion_reverse is the one sampling step in the reverse denoising process.

At 216, generative model 104 determines if there is another time step. For example, generative model 104 determines if all iterations of denoising have been performed for time step t. If another step needs to be performed, the process reiterates to 204 to determine another time step. The process then continues to determine another denoising output.

In some embodiments, the weight values of w_{low} and w_{high} may be different in different time steps. For example, the weight values may change as time steps increase to improve the generated image. In other embodiments, the weight values may not change for all time steps.

When the sampling steps t have been performed, generative model 104 outputs the denoised output. For example, generative model 104 outputs a generated image of an elephant.

The following described the weighted sampling process in more detail.

### Weighted Sampling Process

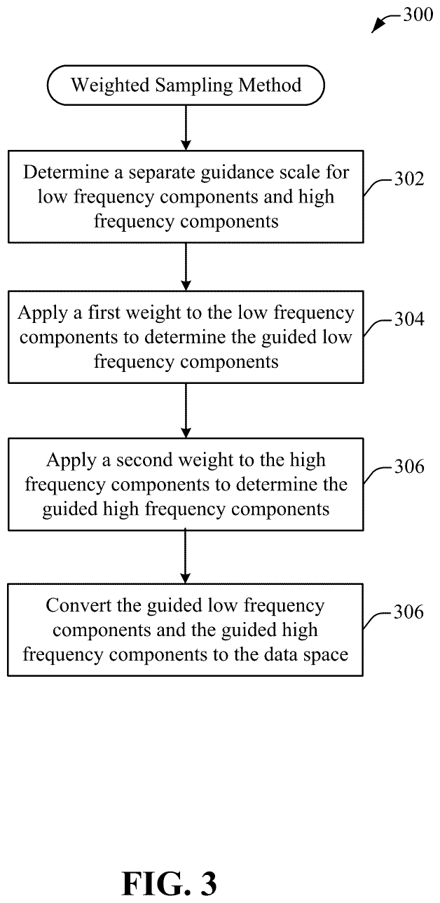

FIG. 3 depicts a simplified flowchart 300 for performing rescaling according to some embodiments. At 302, generative model 104 determines a separate guidance scale for low frequency components and high frequency components. In some embodiments, input may be received that specifies the values of weight w_{low} or second weight w_{high}. Also, set values may be used, or different values may be tested.

At 304, generative model 104 applies a first weight w_{low} to the low frequency components to determine the guided low frequency components of the FDG prediction.

At 306, generative model 104 applies a second weight w_{high} to the high frequency components to determine the guided high frequency components of the FDG prediction.

At 308, generative model 104 converts the guided low frequency components and the guided high frequency components to the data space.

Although images can be generated, generative model 104 may enhance the quality of generated text. To achieve this, generative model 104 generates high-quality text that includes substantial details. Generating such text poses a challenge for standard methods, as high guidance scales often result in unrealistic samples. Generative model 104 addresses this challenge by utilizing the frequency-decoupled guidance (FDG) approach. In some embodiments, generative model 104 separately controls the weights w_{low} and w_{high}. By controlling these components separately, generative model 104 generates realistic text with correct spelling.

### CONCLUSION

Accordingly, generative model 104 examines classifier-free guidance in the frequency domain and determines that its beneficial effects on structural fidelity and fine details result from strong guidance applied to the high-frequency components of the CFG signal. Conversely, generative model 104 finds that excessive guidance on the low-frequency components leads to detrimental impacts on diversity and oversaturation. Building on this insight, generative model 104 uses frequency-decoupled guidance (FDG) to disentangle guidance strength across frequency bands.

In some embodiments, generative model 104 applies conservative scaling to low frequencies while exploiting stronger scaling at high frequencies using FDG, but may use other scales. This approach preserves the diversity and color composition of low guidance scales, similar to those achieved with low CFG values. At the same time, generative model 104 enhances details akin to high guidance scales, thereby improving the overall quality of the generated output. For example, by applying conservative scaling to low frequencies, generative model 104 avoids oversaturation and preserves the natural color composition of the input data. By exploiting stronger scaling at high frequencies, generative model 104 enhances fine details and structural fidelity, resulting in a more realistic and detailed output.

Generative model 104 improves the quality of low CFG scales while avoiding the adverse effects of high CFG scales by design. A key advantage of FDG is that it introduces practically no additional training or sampling cost, making it an efficient and effective solution for enhancing the performance of pretrained diffusion models using CFG. As a result, generative model 104 can be seamlessly integrated as a plug-and-play enhancement to any existing diffusion model, without requiring significant modifications or retraining.

### System

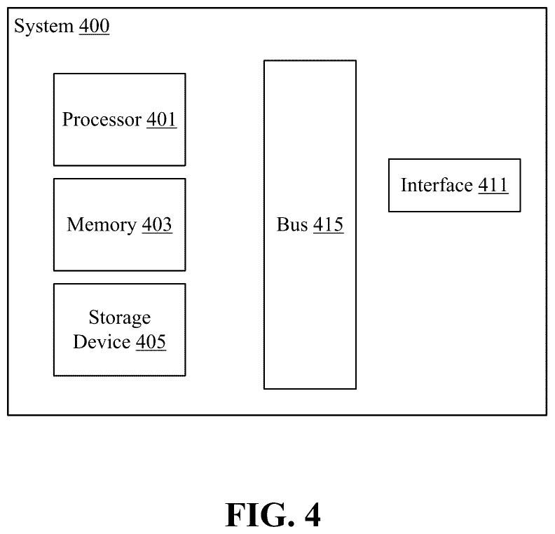

FIG. 4 illustrates one example of a computing device according to some embodiments. According to various embodiments, a system 400 suitable for implementing embodiments described herein includes a processor 401, a memory 403, a storage device 405, an interface 411, and a bus 415 (e.g., a PCI bus or other interconnection fabric.) System 400 may operate as a variety of devices such as generative model 104, or any other device or service described herein. Although a particular configuration is described, a variety of alternative configurations are possible. Processor 401 may perform operations such as those described herein. Instructions for performing such operations may be embodied in memory 403, on one or more non-transitory computer readable media, or on some other storage device. Various specially configured devices can also be used in place of or in addition to processor 401. Memory 403 may be random access memory (RAM) or other dynamic storage devices. Storage device 405 may include a non-transitory computer-readable storage medium holding information, instructions, or some combination thereof, for example instructions that when executed by the processor 401, cause processor 401 to be configured or operable to perform one or more operations of a method as described herein. Bus 415 or other communication components may support communication of information within system 400. The interface 411 may be connected to bus 415 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
determining, by a generative model, a conditional output and an unconditional output for denoising a noisy sample;
determining a frequency decomposition of the conditional output and the unconditional output from a data space to generate a low frequency conditional output, a low frequency unconditional output, a high frequency conditional output, and a high frequency unconditional output;
computing low frequency components by applying a first weight to the low frequency conditional output and the low frequency unconditional output;
computing high frequency components by applying a second weight to the high frequency conditional output and the high frequency unconditional output;
converting the low frequency components and the high frequency components to a guided prediction in the data space; and
determining a denoised output based on the guided prediction, wherein the denoised output is used to generate a generative output by the generative model.

2. The method of claim 1, further comprising:
receiving an input to generate the generative output using the generative model.

3. The method of claim 2, wherein the input is used as a condition to generate the conditional output.

4. The method of claim 2, wherein:
the input comprises a prompt to generate an image, and
the generative output is an image that is generated based on the prompt.

5. The method of claim 1, further comprising:
performing multiple iterations of determining denoised outputs to denoise the noisy sample to the generative output.

6. The method of claim 5, wherein the first weight and the second weight change from a first time step to a second time step in the multiple time steps.

7. The method of claim 5, wherein the first weight and the second weight do not change in the multiple time steps.

8. The method of claim 1, wherein:
the conditional output is generated by the generative model using a condition, and
the unconditional output is generated by the generative model without using the condition.

9. The method of claim 1, wherein determining the frequency decomposition of the conditional output and the unconditional output comprises:
applying a frequency transformation to the conditional output and the unconditional output.

10. The method of claim 1, wherein computing the low frequency components comprises:
applying the first weight to a difference of the low frequency conditional output and the low frequency unconditional output to determine a difference.

11. The method of claim 10, wherein computing the low frequency components comprises:
adding the difference to the low frequency unconditional output.

12. The method of claim 1, wherein computing the high frequency components comprises:
applying the second weight to a difference of the high frequency conditional output and the high frequency unconditional output to determine a difference.

13. The method of claim 12, wherein computing the high frequency components comprises:
adding the difference to the high frequency unconditional output.

14. The method of claim 1, wherein converting the low frequency components and the high frequency components to a guided prediction in the data space comprises:
applying an inverse frequency transformation to the low frequency components and the high frequency components.

15. The method of claim 1, wherein the first weight and the second weight are different values.

16. The method of claim 1, wherein the first weight and the second weight are separate scales.

17. The method of claim 1, wherein the first weight is less than the second weight are different values.

18. The method of claim 1, wherein the denoised output is used to denoise a previously denoised output from a previous time step.

19. A non-transitory computer-readable storage medium having stored thereon computer executable instructions, which when executed by a computing device, cause the computing device to be operable for:
determining, by a generative model, a conditional output and an unconditional output for denoising a noisy sample;
determining a frequency decomposition of the conditional output and the unconditional output from a data space to generate a low frequency conditional output, a low frequency unconditional output, a high frequency conditional output, and a high frequency unconditional output;
computing low frequency components by applying a first weight to the low frequency conditional output and the low frequency unconditional output;
computing high frequency components by applying a second weight to the high frequency conditional output and the high frequency unconditional output;
converting the low frequency components and the high frequency components to a guided prediction in the data space; and
determining a denoised output based on the guided prediction, wherein the denoised output is used to generate a generative output by the generative model.

20. An apparatus comprising:
one or more computer processors; and
a computer-readable storage medium comprising instructions for controlling the one or more computer processors to be operable for:
determining, by a generative model, a conditional output and an unconditional output for denoising a noisy sample;
determining a frequency decomposition of the conditional output and the unconditional output from a data space to generate a low frequency conditional output, a low frequency unconditional output, a high frequency conditional output, and a high frequency unconditional output;
computing low frequency components by applying a first weight to the low frequency conditional output and the low frequency unconditional output;
computing high frequency components by applying a second weight to the high frequency conditional output and the high frequency unconditional output;
converting the low frequency components and the high frequency components to a guided prediction in the data space; and
determining a denoised output based on the guided prediction, wherein the denoised output is used to generate a generative output by the generative model.
